(19) United States
(12) Patent Application Publication
(10) Pub. No.: US 2008/0266903 A1
(43) Pub. Date: Oct. 30, 2008

(54) EAVE LIGHT GUIDING DEVICE AND BACKLIGHT DEVICE USING THE SAME

(75) Inventors: Ying LIU, Hong Kong (HK); Danding Huang, Hong Kong (HK); Shou Lung Chen, Hong Kong (HK)

Correspondence Address: MERCHANT & GOULD PC, P.O. BOX 2903, MINNEAPOLIS, MN, 55402-0903, US

(73) Assignee: Hong Kong Applied Science and Technology Research Institute Co. Ltd., Shatin (HK)

(21) Appl. No.: 12/107,893

(22) Filed: Apr. 23, 2008

(30) Foreign Application Priority Data
Apr. 27, 2007 (CN) 200710097651.7

(51) Int. Cl. F21V 8/00

(52) U.S. Cl. 362/619

(57) ABSTRACT

The present invention provides a multi-block backlight device having light guiding to solve the problems met in the current backlight devices with high cost, difficult matching with the panels, and inefficient lighting area. The multi-block backlight device comprises a plurality of light guiding devices, the light guiding device comprises at least one incident portion, the incident portion comprises at least one light source and an incident area; at least one eave, and a diffusion portion with uniform thickness. The eave can increase effective lighting area of the multi-block backlight device, and the diffusion portion can make the multi-block backlight device easier to couple, therefore achieving cost decreasing and effective usage.

### FIELD OF INVENTION

The present invention relates to a backlight device; more specifically, the present invention relates to a multi-block backlight device having light guiding device.

### BACKGROUND

Backlight devices are a type of lighting device commonly used in Liquid Crystal Displays (LCDs). LCDs use backlight to increase contrast, and also makes the information displayed by the LCDs clear in a dark environment. The presently backlight light source can be Light Emitting Diode (LED), Electroluminescent Panel, Cold Cathode Fluorescent etc., the backlight light source can provide a more uniform light source when combined with a diffusion panel. When using LED as backlight light source, chrominance performance of the LCD can be increased. However, the uniformity of a backlight device is difficult to achieve. In addition, a backlight device also needs to be power saving and with low manufacturing cost.

In order to solve the problems described above, the present technologies including a backlight device 100 as shown in FIG. 1. FIG. 1A is a side view of two coupled backlight devices 100; and FIG. 1B is an elevation view of two coupled backlight devices 100. The backlight device 100 comprises a plurality of LEDs 110; an incident area 120 and a light emitter 130. The plurality of LEDs 110 emit lights penetrating the incident area 120 and reflect against the bottom of the light emitter 130, and emit through a upper surface of the light emitter 130. A plurality of backlight devices 100 can be coupled according to their coupling characteristic, to match difference sizes of panels. However, the backlight device 100 has a wedge shape, which makes it difficult to assemble and requires high precision manufacturing. Furthermore, a single backlight device 100 needs a plurality of LEDs 110 and therefore increases the manufacturing cost of the backlight device 100. Another present technology please refers to FIG. 2. FIG. 2A is a prospective view of a light guiding device 200 in the prior art; and FIG. 2B an elevation view of the light guiding device 200 in the prior art. Light guiding device 200 comprises LED 210 and light emitter 220. Light guiding device 200 solves the problem of backlight device 100 requiring a plurality of LED. However, the effective lighting area of light guiding device 200 is shown by broken line in FIG. 2B, and light guiding device 200 still has areas that do not emit light. Therefore, light guiding device 200 is not effectively used. Additionally, light guiding device 200 cannot be coupled together to form a backlight panel; therefore the manufacturing cost is increased.

Therefore, it requires a backlight device to solve the problems mentioned above, which are high cost, difficult to match with panel sizes and unable to effectively use the lighting area.

### SUMMARY OF INVENTION

In order to solve the above-mentioned problems, the present invention provides a light guiding device, comprising at least one incident portion with at least one light source and an incident area; a diffusion portion having uniform thickness; and at least one eave connected to the diffusion portion to form a light output surface of the light guiding device.

The present invention provides a multi-block backlight device, comprising a plurality of above-mentioned light guiding device.

### BRIEF DESCRIPTION OF THE DRAWINGS

FIG. 1A is a side view of two coupled backlight devices of the prior art.

FIG. 1B is an elevation view of two coupled backlight devices of the prior art.

FIG. 2A is a prospective view of a light guiding device in the prior art.

FIG. 2B is an elevation view of the light guiding device in the prior art.

FIG. 3 is a prospective view of a light guiding device according to the present invention

FIG. 4 is a prospective view of another light guiding device according to the present invention

FIG. 5 is a prospective view of another light guiding device according to the present invention.

FIG. 6 is a zoom-in view of an incident portion of a light guiding device.

FIG. 7 is a prospective view of another light guiding device according to the present invention.

FIG. 8 is a prospective view of another light guiding device according to the present invention.

FIG. 9 is a prospective view of another light guiding device according to the present invention.

FIG. 10 is a prospective view of backlight device according to the present invention.

FIG. 11 is a prospective view of a multi-block backlight device according to the present invention.

FIG. 12 is a prospective view of another multi-block backlight device according to the present invention.

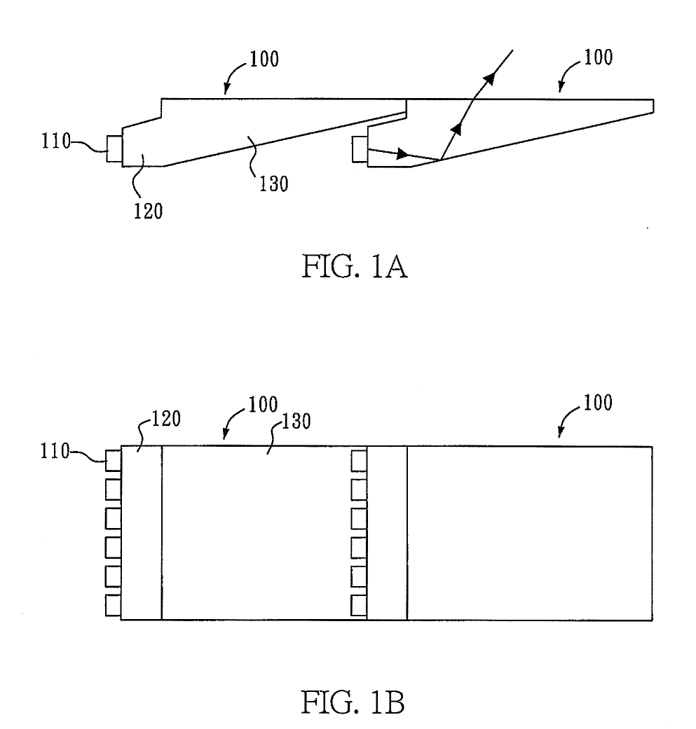

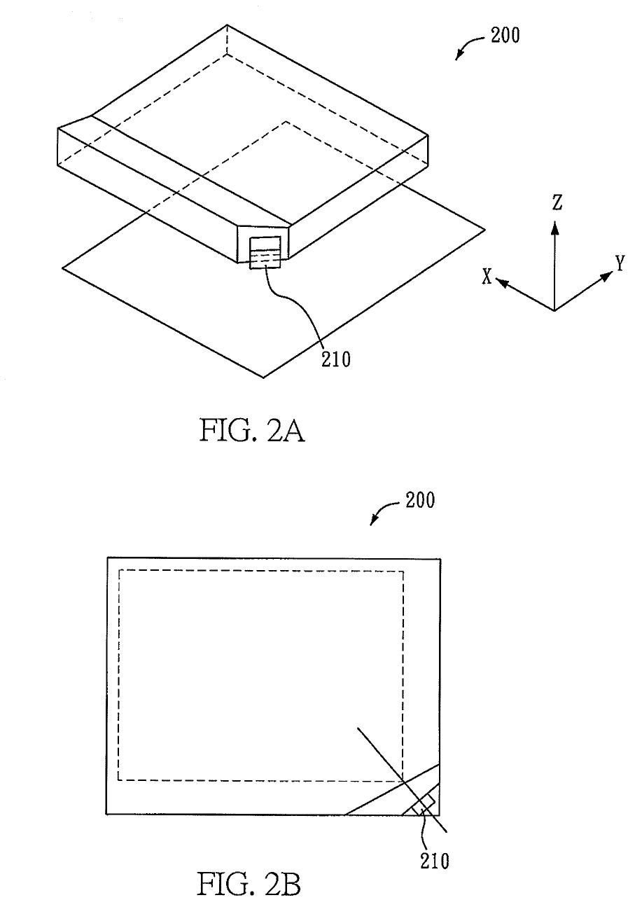

### DETAILED DESCRIPTION OF THE INVENTION

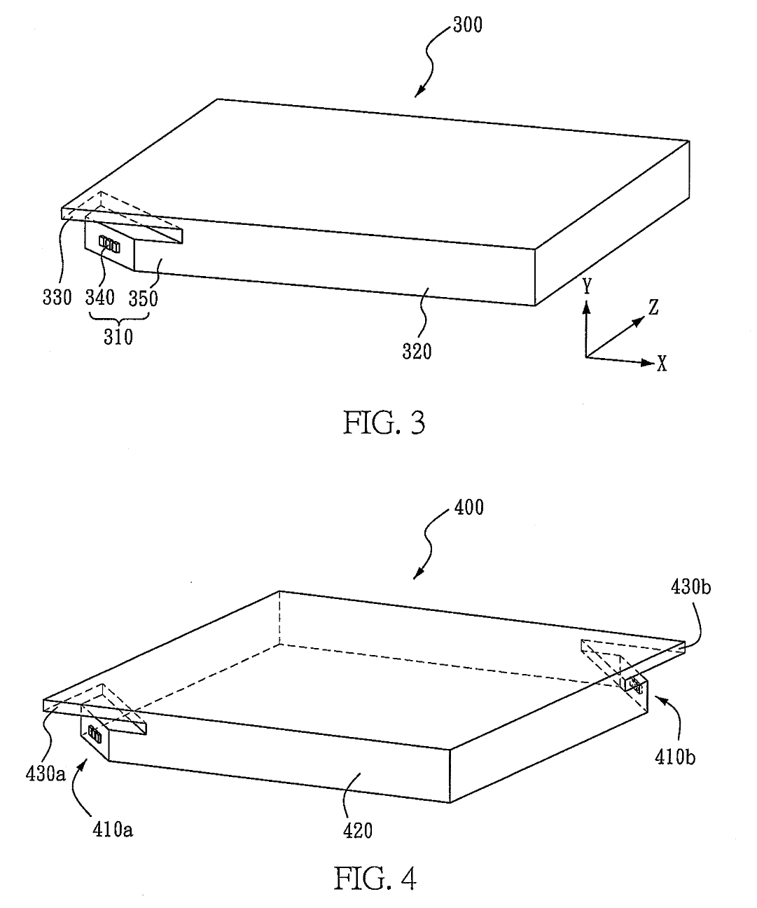

FIG. 3 is a prospective view of a light guiding device 300 according to the present invention. The light guiding device 300 comprises an incident portion 310; a diffusion portion 320 and an eave 330; wherein the incident portion 310 comprises a light source 340 and an incident area 350. The incident portion 310 is connected to the diffusion portion 320, and the incident portion 310 is at a corner of the light guiding device 300. The eave 330 is above the incident portion 310, and a surface of the eave 330 and a surface of the diffusion portion 320 together forms a surface of the light guiding device 300. The diffusion portion 320 has uniform thickness. And the light source 340 of the incident area 350 is formed by one or more LEDs.

The light source 340 emits lights that pass through the incident portion 310 and enter the diffusion portion 320. In addition, since the eave 330 is connected to the diffusion portion 320, lights diffused from the diffusion portion 320 enter the eave 330, diffuse from a bottom side of the eave 330 and uniformly emit out from an upper surface. Therefore, the effective lighting area of the light guiding device 300 in the present invention is the entire surface, and only one light source 340 is provided. Therefore, achieving cost decreasing and effective usage of the light guiding device 300.

FIG. 4 is a prospective view of another light guiding device 400 according to the present invention. Light guiding device 400 is similar to the above-mentioned light guiding device 300, with the differences being that light guiding device 400 has two incident portions 410a and 410b, and two eaves 430a and 430b respectively disposed at two opposite corners of light guiding device 400, which allows the light guiding device 400 to provide a more uniform light output.

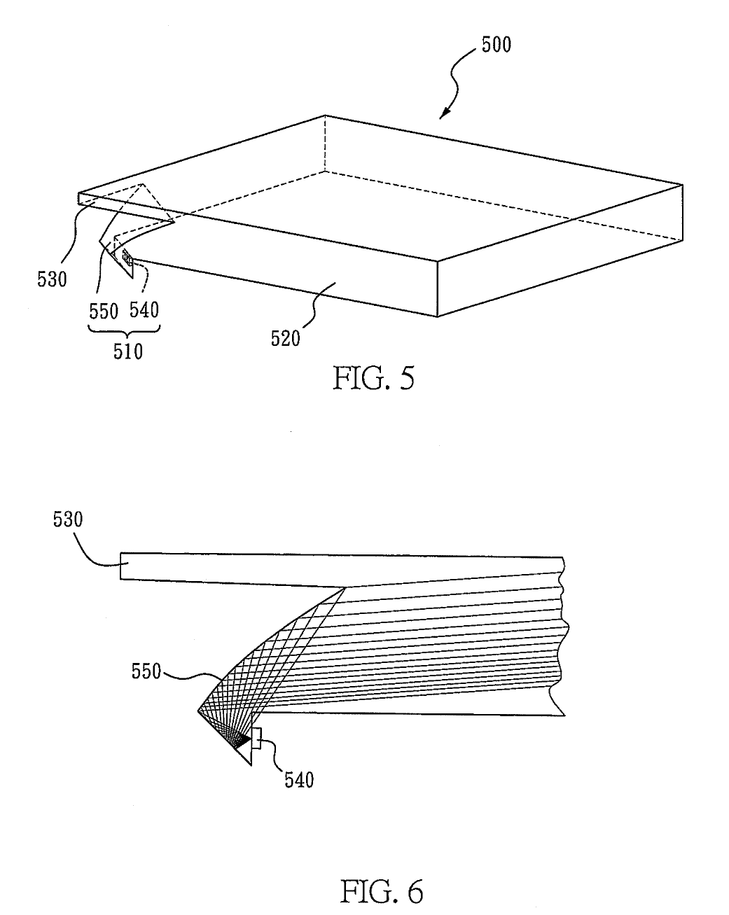

FIG. 5 is a prospective view of another light guiding device 500 according to the present invention. Light guiding device 500 is similar to the above-mentioned light guiding device 300, with the differences being that an upper surface of incident area 550 of light guiding device 500 is a parabolic surface. As shown in FIG. 6, FIG. 6 is a zoom-in view of incident portion 510 of light guiding device 500. Light source 540 uses the parabolic surface of incident area 510 to reflect light, and light enters diffusion portion 520 after reflection. Lights entered from reflection can make an entire surface of light guiding device 500 glow, and provide a more uniform light source, which increases coupling efficiency in incident portion 510 and hence increases efficiency in light usage.

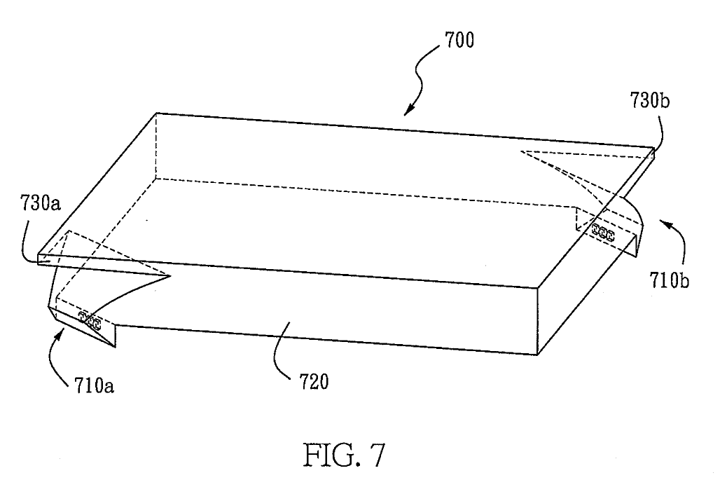

FIG. 7 is a prospective view of another light guiding device 700 according to the present invention. Light guiding device 700 is similar to the above-mentioned light guiding device 500, with the differences being that light guiding device 400 has two incident portions 710a and 710b, and two eaves 730a and 730b respectively disposed at two opposite corners of light guiding device 700, which allows the light guiding device 700 to provide a more uniform light output.

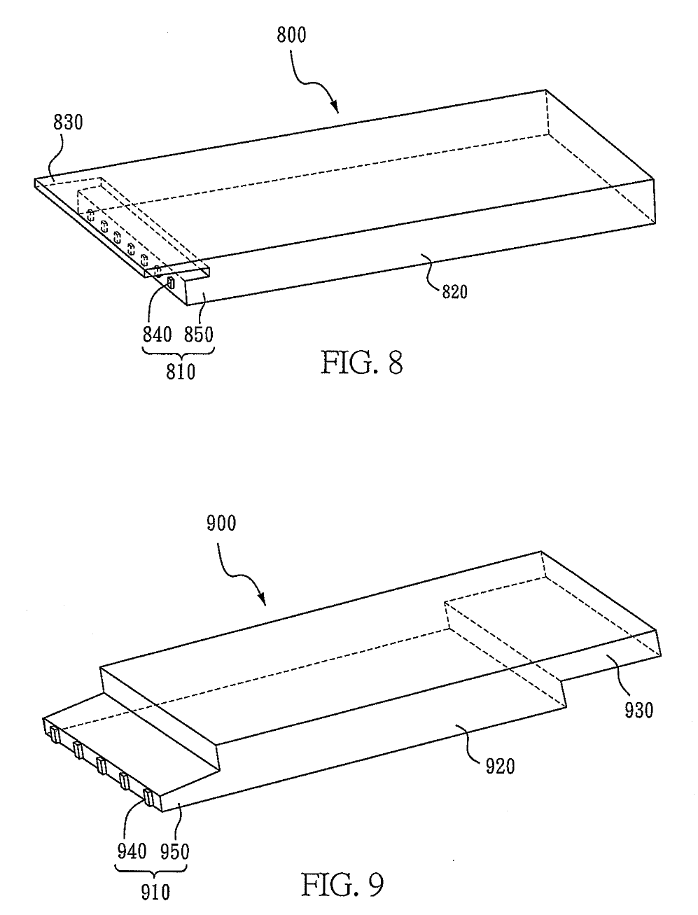

FIG. 8 is a prospective view of another light guiding device 800 according to the present invention. Light guiding device 800 comprises an incident portion 810; a diffusion portion 820 and an eave 830; wherein the incident portion 810 comprises at least one light source 840 and incident area 850, and light source 840 can be composed of one or more LEDs. Incident portion 810 is connected to diffusion portion 820 and incident portion 810 is on one side of light guiding device 800. The eave 830 is above the incident portion 810, and a surface of the eave 830 and a surface of the diffusion portion 820 together form a surface of the light guiding device 800. The diffusion portion 820 has uniform thickness.

The light source 840 emits lights that pass through the incident portion 810 and enter the diffusion portion 820. In addition, since the eave 830 is connected to the diffusion portion 820, lights diffused from the diffusion portion 820 enter the eave 830, diffuse from a bottom side of the eave 830 and uniformly emit out from an upper surface. Therefore, the effective lighting area of the light guiding device 800 in the present invention is the entire upper surface, achieving cost decreasing and effective usage of the light guiding device 800.

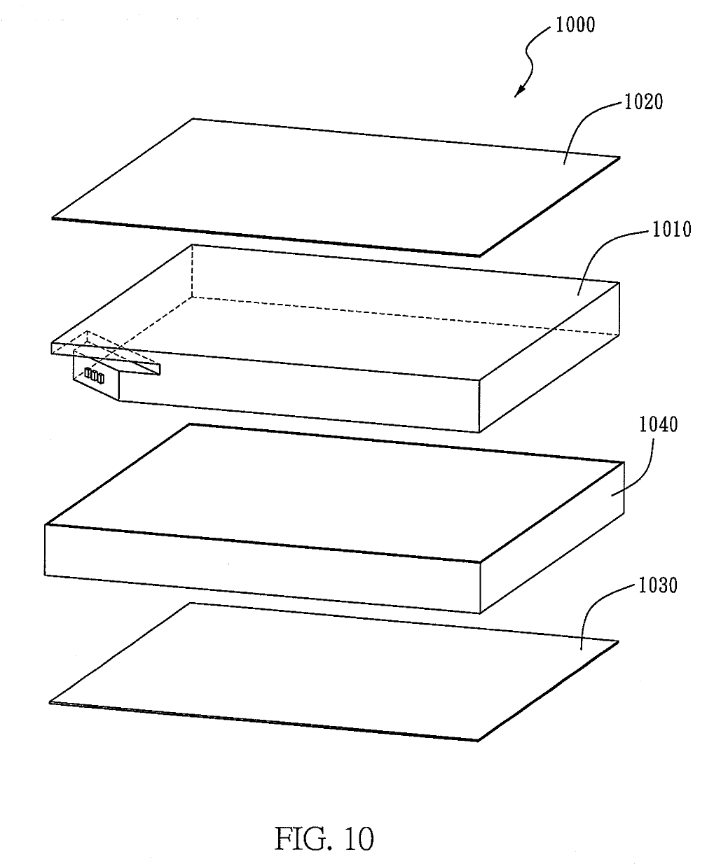

FIG. 9 is a prospective view of another light guiding device 900 according to the present invention. Light guiding device 900 comprises an incident portion 910; a diffusion portion 920 and an eave 930; wherein the incident portion 910 comprises at least one light source 940 and incident area 950, and light source 940 can be composed of one or more LEDs. Incident portion 910 is connected to diffusion portion 920 and incident portion 910 is on a side of light guiding device 900. The eave 930 is on the opposite side of incident portion 910, and a surface of the eave 930 and a surface of the diffusion portion 920 together forms a surface of the light guiding device 900. The diffusion portion 920 has uniform thickness.

Diffusion portion 920 of light guiding device 900 has a uniform thickness, which allows easy assembly without high precision manufacturing techniques; therefore significantly reduces manufacturing cost. And eave 930 is connected to diffusion portion 920, lights diffused from the diffusion portion 920 enter the eave 930, diffuse from a bottom side of the eave 930 and uniformly emit out from an upper surface. This does not limit the effective lighting area of light guiding device 900.

FIG. 10 is a prospective view of a backlight device 1000 according to the present invention. Backlight device 1000 comprises a light guiding device 1010; a diffusion device 1020 and a reflecting device 1030. Wherein light guiding device 1010 shown is light guiding device 300 or any one of light guiding devices described above. As shown in FIG. 10, diffusion device 1020 is disposed above light guiding device 1010 and light guiding device 1010 is disposed above reflecting device 1030. Lights emitted from light guiding device 1010 in all directions can be reflected to diffusion device 1020 by reflecting device 1030, or direct to diffusion device 1020 before emitting through diffusion device 1020. Backlight device 1000 can further comprise a side-reflecting device 1040 for increasing light usage efficiency, so that light emitted from light guiding device 1010 is able to uniformly reflect to diffusion device 1020.

FIG. 11 is a prospective view of a multi-block backlight device 1100 according to the present invention, comprising 9 backlight devices 1000 as described above. Multi-block backlight device 1100 meets the different size requirement by coupling a plurality of backlight devices 1000, and because of backlight devices 1000 are uniformly shaped, coupling each with another can be easily done. FIG. 11 displays only a multi-block backlight device 1100 formed with backlight device 1000 of light guiding device 300, wherein light guiding device can also be light guiding device 300, 400, 500, 700 or 800.

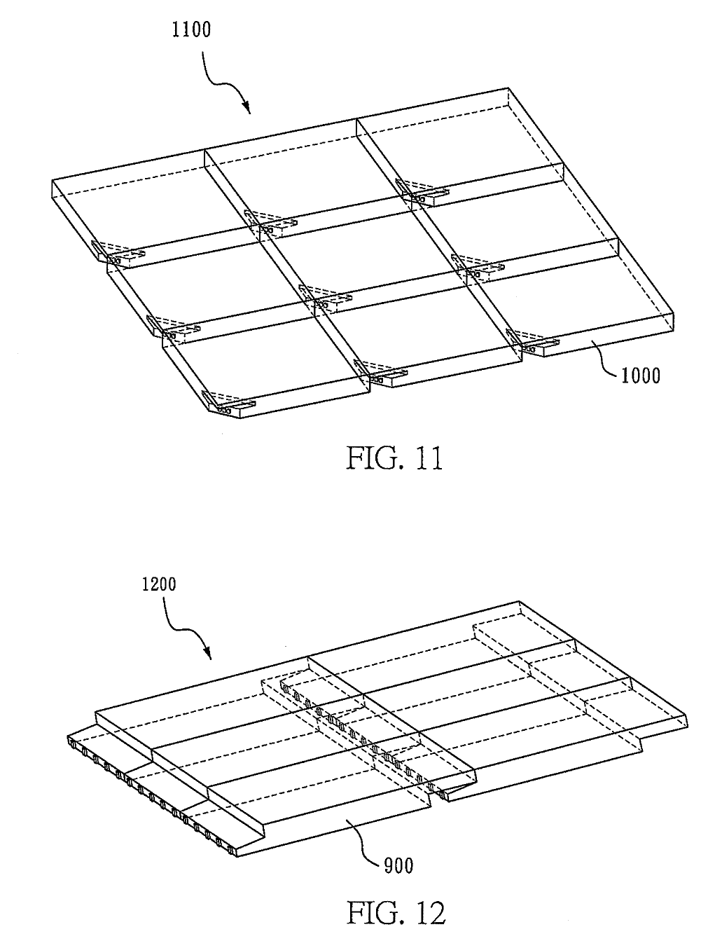

FIG. 12 is a prospective view of another multi-block backlight device 1200 according to the present invention, comprising backlight device 1000 formed of 6 light guiding devices 900. Multi-block backlight device 1200 meets the different sizes requirement by coupling a plurality of backlight devices 1000, and because of backlight devices 1000 are uniformly shaped, coupling each with another can be easily done.

Although the technical contents and features of the present invention are disclosed as above, persons skilled in the art should practice this invention with necessary modifications without departing from scope of the present invention. Therefore, the scope of the present invention is not limited to disclose embodiments; modifications and alternations without departing from scope of the present invention shall be seen as covered by those claimed.

1. A light guiding device, comprising:
at least one incident portion comprising at least one light source and an incident area;
a diffusion portion having uniform thickness; and
at least one eave connected to the diffusion portion.

2. The light guiding device according to claim 1, wherein the incident portion is disposed at a corner of the light guiding device, and the eave is disposed above the incident portion.

3. The light guiding device according to claim 1, wherein the incident portion is disposed at two opposite corners of the light guiding device, and the eave is disposed above the incident portion.

4. The light guiding device according to claim 1, wherein the incident portion is disposed on a side of the light guiding device, and the eave is disposed above the incident portion.

5. The light guiding device according to claim 1, wherein the incident portion is disposed on a side of the light guiding device, and the eave is disposed on an opposite side of the incident portion.

6. The light guiding device according to claim 1, wherein the light source comprises at least one light emitting diode (LED).

7. The light guiding device according to claim 6, wherein the at least one LED comprises a red LED, a green LED and a blue LED.

8. The light guiding device according to claim 1, wherein the light source can be OLED, LED or CCFL.

9. The light guiding device according to claim 1, wherein a surface of the incident area is a horizontal surface or an oblique surface.

10. The light guiding device according to claim 1, wherein a surface of the incident area is a parabolic surface.

11. The light guiding device according to claim 1, further comprising at least one reflecting device; and at least one diffusion device; wherein the reflecting device is disposed on a side of the light guiding device and the diffusion device is disposed on an opposite side of the reflecting device.

12. The light guiding device according to claim 1, further comprising at least one side-reflecting device disposed on at least one side of the light guiding device perpendicular to the reflecting device.

13. A multi-block backlight device having a plurality of light guiding devices, the light guiding device comprising:
at least one incident portion having at least one light source and an incident area;
a diffusion portion having uniform thickness; and
at least one eave connected to the diffusion portion

14. The multi-block backlight device according to claim 13, wherein the incident portion of the light guiding device is disposed at a corner of the light guiding device, and the eave is disposed above the incident portion.

15. The multi-block backlight device according to claim 13, wherein the incident portion of the light guiding device is disposed at two opposite corners of the light guiding device, and the eave is disposed above the incident portion.

16. The multi-block backlight device according to claim 13, wherein the incident portion of the light guiding device is disposed on a side of the light guiding device, and adjacent to the eave of the light guiding device above the incident portion.

17. The multi-block backlight device according to claim 13, wherein the incident portion of the light guiding device is disposed on a side of the light guiding device, and the eave is disposed on an opposite side of the incident portion.

18. The multi-block backlight device according to claim 13, wherein the light source of the light guiding device comprises at least one LED.

19. The multi-block backlight device according to claim 18, wherein the at least one LED of the light guiding device comprises a red LED, a green LED and a blue LED.

20. The multi-block backlight device according to claim 13, wherein the light source can be OLED, LED or CCFL.

21. The multi-block backlight device according to claim 13, wherein a surface of the incident area of the light guiding device is a horizontal surface or an oblique surface.

22. The multi-block backlight device according to claim 13, wherein a surface of the incident area of the light guiding device is a parabolic surface.

23. The multi-block backlight device according to claim 13, further comprising at least one side-reflecting device disposed on at least one side of the light guiding device perpendicular to the light guiding device.

24. The multi-block backlight device according to claim 13, further comprising at least one bottom side-reflecting device disposed on a bottom side of the light guiding device parallel to the light guiding device.
